(19) United States
(12) Patent Application Publication
(10) Pub. No.: US 2017/0276481 A1
(43) Pub. Date: Sep. 28, 2017

(54) ELECTRONIC RANGE ESTIMATOR FOR ACCURATELY ESTIMATING THE DISTANCE OF A REMOTE OBJECT

(71) Applicant: Marc Vayn, South San Francisco, CA (US)

(72) Inventor: Marc Vayn, South San Francisco, CA (US)

(21) Appl. No.: 15/077,778

(22) Filed: Mar. 22, 2016

(51) Int. Cl. G01C 3/04; F41G 1/38; F41G 1/473; G01C 19/02

(52) U.S. Cl. CPC G01C 3/04; G01C 19/02; F41G 1/38; F41G 1/473

(57) ABSTRACT

The present invention relates to an electronic range estimator for accurately measuring the distance/range of the remote object that is seen through the smart weapon scope device. The distance/range of the remote object is measured based on the vertical height of the remote object and the orientation angles measured for the remote object. Further, the electronic range estimator computes the distance/range of the remote object based on the vertical height of the remote object and the orientation angles measured for the remote object.

### FIELD OF THE INVENTION

The present invention generally relates to an electronic range estimator and more particularly relates to implementing a system and method for accurately estimating the distance of a remote object with the usage of electronic instruments such as digital angular rate gyroscope sensor and a digital accelerometer sensor associated with a smart weapon scope device.

### BACKGROUND OF THE INVENTION

The present invention relates, in general, to the field of range measuring equipment. More particularly, this invention relates to a digital image processing system that is capable, through a use of an inclinometer, to identify the orientation of the object in the 3D physical space.

In the current scenario, a laser range technology is commonly used to determine the distance of a remote object. However, the laser range technology is encountered with a number of limitations while determining the distance of the remote object. For example, the technology requires a laser to be reflected off the target object; therefore it cannot be used effectively to identify distances of the objects that have poor or non reflective surfaces. Further, the laser range finders are associated with distance limitations due to the impact of the laser emitter power, which is determined, based on the distance of the target object. Further, the laser range finders have a greater chance of missing the reference objects to be captured based on the distance of the reference object.

Hence, there is a need for a better system that guarantees accurate distance measurement unlike laser range finders, which have distance limitations that are associated with the power of a laser emitter. Further, the system must be configured to virtually override the distance limitation as long as the reference object is visible through its digital camera. Further, the system must be capable of overcoming the limitation of accurate measurement of distant targets, and to guarantee that the laser beam aims accurate measurement of distant targets without missing the target, potentially introducing a significant opportunity for erroneous distance measurements.

### SUMMARY OF THE INVENTION

The present invention relates to an electronic range estimator that is used for accurately measuring the distance of a remote object. Further, the electronic range estimator implements a method wherein said method comprises of accepting the vertical size of the remote object, determining the orientation angle by considering the top edge of the remote object; determining the orientation angle by considering the bottom edge of the remote object; and measuring the distance of the remote object based on the vertical size of the remote object and the orientation angles measured by considering the top edge and the bottom edge of the remote object.

Further, the present invention supports a range estimation measurement system for accurately measuring the distance of a remote object, wherein the system comprises of a digital angular rate gyroscope sensor, a digital accelerometer sensor, and the system is configured to accept the vertical size of the remote object. Further, the system is configured to determine an orientation angle from the top edge of the remote object and the bottom edge of the remote object using the digital angular rate gyroscope sensor. Further, the system is configured to compute the distance of the remote object by considering the vertical size of the remote object along with the orientation angles measured for the remote object using the digital accelerometer sensor.

### BRIEF DESCRIPTION OF DRAWINGS

FIGS. 1a, 1b, and 1c illustrate a working overview of a system for accurately measuring the distance/range of a remote object from the smart weapon scope device.

FIG. 2 illustrates a flow-chart that explains the working of the system for accurately measuring the distance/range of a remote object from the smart weapon scope device.

FIG. 3 illustrates an overview of components used for implementing the method of measuring the distance/range of a remote object from the smart weapon scope device.

### FIGURE DESCRIPTION

101—A scoping device focusing a remote object
102—A remote object focused by the scoping device
103—Marking of the top edge of the remote object
104—Marking of the bottom edge of the remote object
105—A center location of the remote object that is focused by the scoping device.
200—A flow-chart explaining the process of estimating the distance/range of a remote object from the smart weapon scope device
300—A system overview of components used to implement the method of estimating the distance/range of the remote object from the smart weapon scope device
301—A Display module
302—A Scope module
303—A Profile configuration module
304—A Distance computation module
305—A Control module

### DETAILED DESCRIPTION OF THE INVENTION

The following detailed description of the preferred embodiments presents a description of certain specific embodiments to assist in understanding the claims. However, the present invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be evident to one of ordinary skill in the art that the present invention may be practiced without these specific details.

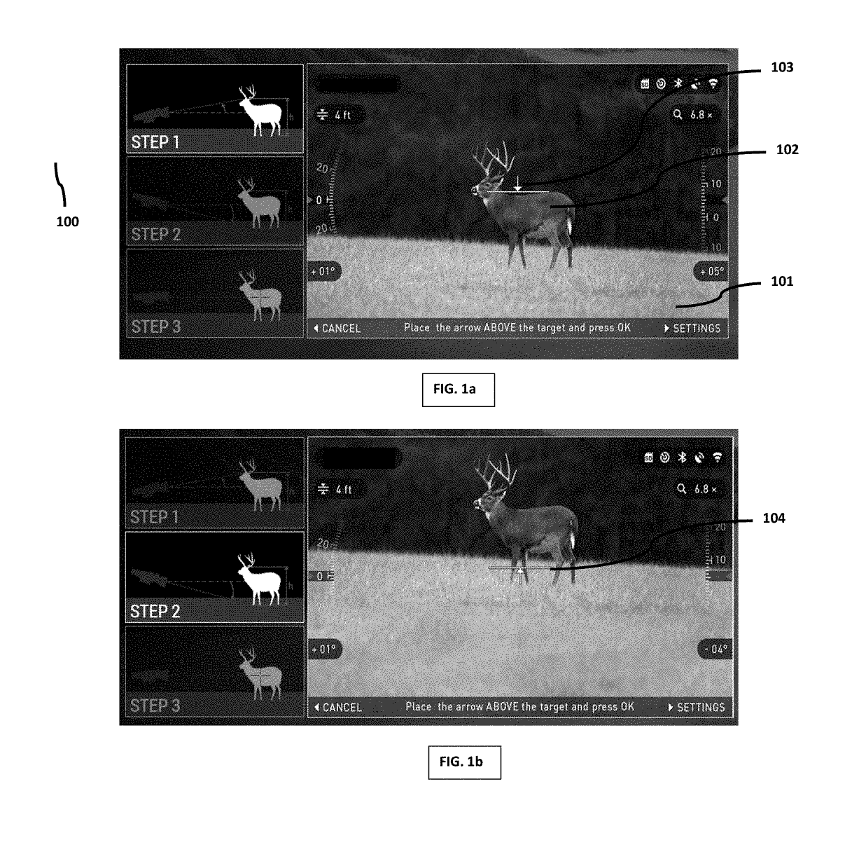

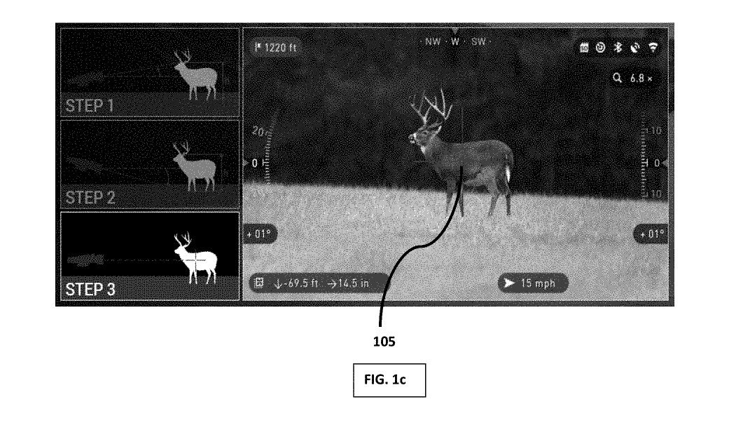

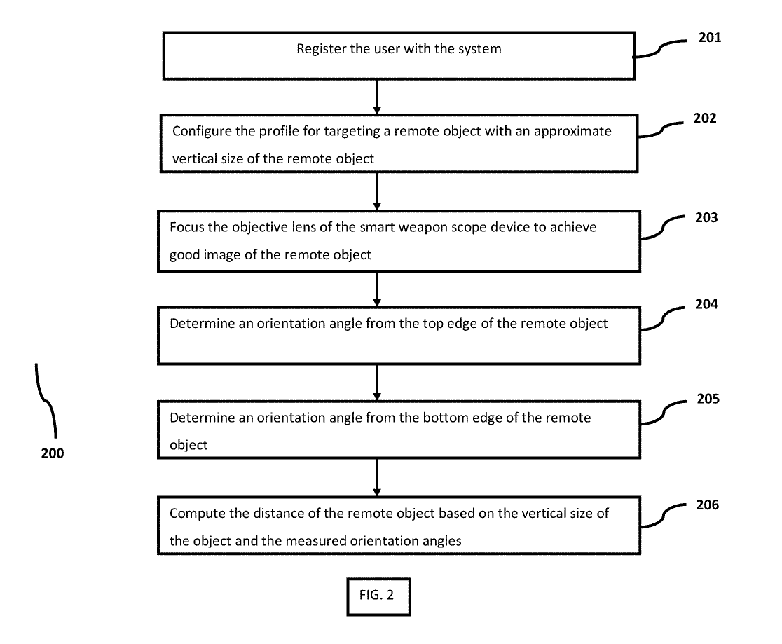

Referring to FIGS. 1a, 1b, and 1c illustrate a working overview of the system 100 for accurately measuring the distance/range of a remote object from the smart weapon scope device. As depicted in FIG. 1a, the user is allowed to focus the remote object 102 through the scoping lens 101 and to select the top edge of the focused object 103. Based on the selection of the top edge of the focused object 103, the system 100 determines the orientation angle of the remote object through the use of the digital angular rate gyroscope sensor. Further, as depicted in FIG. 1b, the user is allowed to focus the remote object 102 through the scope's objective lens 101 and select the bottom edge of the focused object 103. Based on the selection of the bottom edge of the focused object 103, the system 100 automatically determines the orientation angle of the remote object through the use of the digital angular rate gyroscope sensor. In an embodiment, the system 100 allows the user to specify a known or approximate vertical height of the remote object. Further, as depicted in FIG. 1c, the system 100 accurately determines the distance range of the remote object 105 based on the orientation angles (the top edge and the bottom edge) measured for the remote object and the vertical height specified for the remote object.

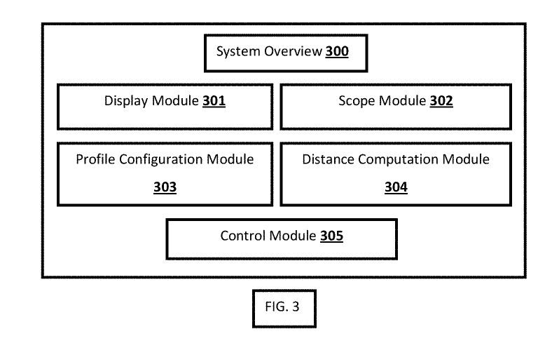

Referring to FIG. 2 illustrates a flow-chart 200 that explains the working of the system100 for accurately measuring the distance/range of a remote object from the smart weapon scope device. Initially, at step 201, the user registers with the system 100 for accurately measuring the distance/range of the remote object from the smart weapon scope device. Further, at step 202, as the user successfully registers with the system 100, the system 100 allows the registered user to configure the profile in the smart weapon scope device with an approximate vertical size of the remote object. Further, at step 203, the system 100 is configured to allow the user to focus and capture the remote object within the scope lens of the smart weapon scope device. Further, at step 204, the system 100 is configured to determine the orientation angle of the remote object that is measured from the top edge of the focused remote object as the user selects the top edge of the focused object. Further, at step 205, the system 100 is configured to determine the orientation angle of the remote object that is measured from the bottom edge of the focused remote object as the user selects the bottom edge of the focused object. In an embodiment, the system 100 uses a digital angular rate gyroscope sensor to measure the orientation angles of the top edge and the bottom edge of the remote object. Further, at step 206, the system 100 is configured to compute the distance range of the remote object based on the vertical size of the remote object and the orientation angles measured for the remote object. In an embodiment, the system 100 uses a digital accelerometer sensor to compute the distance range of the remote object based on the vertical size and the orientation angles determined for the remote object.

Referring to FIG. 3 illustrates an overview of components 300 used for implementing the method of measuring the distance/range of a remote object from the smart weapon scope device. In an embodiment, the following components 300 are used for implementing the method of measuring the distance/range of the remote object from the smart weapon scope device: a Display module301, a Scoping module 302, a Profile Configuration module 303, a Distance Computation module 304, and a Control module 305. The Display module 301 is configured to display the remote object that is focused through the smart weapon scope device. The Scope module 302 is designed to focus the device on the remote object, wherein the device can focus on the top edge, the bottom edge, and/or the center of the remote object. The Profile Configuration module 303 is configured to set the profile parameters for using the smart weapon scope device while capturing the remote object. The profile parameters include information about the vertical size of the remote object that is known or considered to be an approximate value, along with other parameter details such as Environmental conditions, sensors used to measure the orientation angles, the system resolution used for capturing the remote object, the accessories associated with the smart weapon scope device, or the like. The Distance Computation module 304 is configured to compute the distance of the remote object that is focused through the smart weapon scope device, wherein the distance of the remote object is computed based on the vertical size of the object and the orientation angles measured from the top edge and the bottom edge of the remote object. The Control module 305 is configured to transfer data across various modules supported within the system 100.

1. A method for accurately measuring the distance of a remote object, wherein said method comprises of:
accepting the vertical size of said remote object;
determining the orientation angle by considering the top edge of said remote object; and
determining the orientation angle by considering the bottom edge of said remote object.
measuring the distance of the remote object based on the vertical size of said remote object, and the orientation angle measured by considering the top edge and the bottom edge of said remote object.

2. The method as claimed in claim 1, wherein said method accepts the vertical size of said remote object through one of the following ways:
considering the vertical size value provided by a user through the user interface;
based on a profile configuration value settings provided in the smart scope device.

3. The method as claimed in claim 1, wherein said method determines the orientation angle by focusing a reticle of said smart scope device either on the top edge of the remote object or at the bottom edge of the remote object.

4. A range estimation measurement system for accurately measuring the distance of a remote object, wherein said system comprises of a digital angular rate gyroscope sensor, a digital accelerometer sensor and said system is configured to:
accept the vertical size of said remote object;
determine an orientation angle from the top edge of said remote object using said digital angular rate gyroscope sensor;
determine an orientation angle from the bottom edge of said remote object using said digital angular rate gyroscope sensor; and
compute the distance of the said remote object by considering the vertical size of said remote object along with the orientation angle measured for said remote object using said digital accelerometer sensor.

5. The system as claimed in claim 4, wherein said system is configured to accept the vertical size of said remote object through one of the following ways:
considering the vertical size value provided by a user through the user interface;
based on a profile configuration value settings provided in the smart scope device.

6. The system as claimed in claim 4, wherein said system is configured to determine the orientation angle by focusing a reticle of said smart scope device either on the top edge of the remote object or at the bottom edge of the remote object.

7. A computer program product comprising computer executable program code recorded on a computer readable non-transitory storage medium, said computer executable program code when executed accurately estimates the distance of a remote object, causing the actions including:
accepting the vertical size of said remote object from a user through a user interface;
determining an orientation angle from the top edge of said remote object using said digital angular rate gyroscope sensor;
determining an orientation angle from the bottom edge of said remote object using said digital angular rate gyroscope sensor; and
computing the distance of the said remote object by considering the vertical size of said remote object along with the orientation angle measured for said remote object using said digital accelerometer sensor.

8. The computer program product as claimed in claim 7, wherein said product is configured to accept the vertical size of said remote object through one of the following ways:
considering the vertical size value provided by a user through the user interface;
based on a profile configuration value settings provided in the smart scope device.

9. The computer program product as claimed in claim 7, wherein said product is configured to determine the orientation angle by focusing a reticle of said smart scope device either on the top edge of the remote object or at the bottom edge of the remote object.
